(19) United States
(12) Patent Application Publication
(10) Pub. No.: US 2021/0153461 A1
(43) Pub. Date: May 27, 2021

(54) NOISE ATTENUATION EARPHONE DEVICE FOR ANIMALS

(71) Applicants: Daniel FERLAND, Montreal (CA); Stéphane DEDIEU, Ottawa (CA)

(72) Inventors: Daniel FERLAND, Montreal (CA); Stéphane DEDIEU, Ottawa (CA)

(21) Appl. No.: 16/480,915

(22) PCT Filed: Jan. 26, 2018
(86) PCT No.: PCT/CA2018/050092

§ 371 Date: Jul. 26, 2019

Related U.S. Application Data
(60) Provisional application No. 62/450,915, filed on Jan. 26, 2017.

(51) Int. Cl. A01K 15/02; A01K 11/00; A01K 29/00; H04R 1/10

(52) U.S. Cl. CPC A01K 15/021; A01K 11/008; H04R 1/1075; H04R 1/1016; A01K 29/005

(57) ABSTRACT

An interactive animal earphone device for providing noise attenuation, as well as voice commands, in noisy environments is described. The device typically includes a core member, and an audio processing system (at least a processing device combined with an in-ear speaker, and alternatively, combined with an outer-ear microphone and an in-ear canal microphone) for capturing/transmitting/interpreting sounds from the animal (including biological noises captured in the ear canal) and digitally controlling over the animal perception of its sound environment. The earphone device may further include, without limitation, a tracking technology (GPS module), a gyroscope, health monitoring sensors, a wireless module, and a memory for storing data recorded from in-ear canal and outer-ear microphones and other sensors. Along with voice commands and sounds from the animal, data from all sensors, the gyroscope, and the GPS module can be sent to a receiving device or external device, such as, without limitation, a smartphone, a computer and/or a tablet, in real-time over a wireless network, either cellular network, WLAN or wireless personal area network (WPAN) (Bluetooth™).

### CROSS-REFERENCE TO RELATED APPLICATIONS

This application claims priority from U.S. Provisional Application No. 62/450,915 filed on Jan. 26, 2017.

### TECHNICAL FIELD

The present disclosure relates to noise attenuation earphone devices. More particularly, the present disclosure relates to noise attenuation devices, or noise reduction devices, adapted for animals, which allow interactive communication with the animal, especially in noisy environments.

### BACKGROUND

There exist in the art passive noise attenuation, reduction, or cancellation devices that are adapted for animals. As per example, noise reduction earplugs for horses may easily be found in specialized stores. Indeed, Prior Art FIG. 1 illustrates earplugs adapted for horses. Such earplugs consist of two related pieces of expanding foam 1 that can be compressed and inserted in the horse ear canals. Horse earplugs are used for attenuating ambient noise and therefore, for keeping the animal's attention and preventing/reducing its nervousness, its aggressiveness, its stress level, and the like, during important events such as, competitions, races, animal shows, police operations in crowded areas, vehicle transportation, and the like. Unfortunately, when being used, such earplugs filter human voice medium and high frequency content and thus degrade voice command intelligibility so that the overall communication quality with the horse is lost. Furthermore, existing passive hearing protection devices are known to have limited noise attenuation capabilities at low frequencies.

There also exist in the art wireless communication devices, which are adapted for animals, and that allow voice commands (human to animal). As per example, Prior Art FIG. 2 illustrates an application for an interactive communication and tracking dog collar 2. In spite of a small loudspeaker that is integrated in the dog's collar, the device fails at sending clear and intelligible voice commands to the animal's ears in noisy and/or windy environments.

Accordingly, there is a need for an improved noise attenuation earphone device for animals.

### SUMMARY

It is an object of the present disclosure to provide a noise attenuation earphone device that overcomes or mitigates one or more disadvantages of known noise attenuation devices or at least provides a useful alternative.

According to an embodiment, there is provided an animal noise attenuation earphone device comprising: a core member of a substantially resilient material adapted for filling an animal ear canal in a way to attenuate environmental sounds; and an audio processing system within the core member for providing controlled sounds towards the animal ear canal, the audio processing system comprising: a processing device; and an in-ear speaker operatively coupled to the processing device for providing the controlled sounds towards the animal ear canal.

According to an embodiment, there is provided the animal noise attenuation earphone device of above, wherein the audio processing system further comprises: an outer-ear microphone operatively coupled to the processing device for capturing environmental sounds; and an in-ear canal microphone operatively coupled to the processing device for receiving animal sounds.

According to an embodiment, there is provided the animal noise attenuation earphone device of above, further comprising a memory accessible by the processing device for storing at least one of: the controlled sounds and the animal sounds received.

According to an embodiment, there is provided the animal noise attenuation earphone device of above, further comprising a communication module operatively connected to the processing device for at least one of: receiving the controlled sounds and transmitting the animal sounds received.

According to an embodiment, there is provided the animal noise attenuation earphone device of above, further comprising a USB port.

According to an embodiment, there is provided the animal noise attenuation earphone device of above, wherein the communication module is connected to the processing device for at least one of: remotely receiving the controlled sounds and remotely transmitting the animal sounds received.

According to an embodiment, there is provided the animal noise attenuation earphone device of above, wherein the communication module comprises: a transmitting and receiving communication antenna for wireless communication with an external device.

According to an embodiment, there is provided the animal noise attenuation earphone device of above, wherein the external device comprises at least one of: a phone device, a computer device, a headset device, an external microphone device and a music device.

According to an embodiment, there is provided the animal noise attenuation earphone device of above, wherein the in-ear speaker is operatively coupled to the processing device for providing the controlled sounds towards the animal ear canal at a frequency up to at least 35 kHz.

According to an embodiment, there is provided the animal noise attenuation earphone device of above, wherein the communication module is one of: a cellular engine wirelessly connected to a cellular network; a Wi-Fi module wirelessly connected to a Wi-Fi network; and a Bluetooth module wirelessly connected to a Bluetooth network.

According to an embodiment, there is provided the animal noise attenuation earphone device of above, further comprising a sensor operatively coupled to the processing device for collecting animal complementary data.

According to an embodiment, there is provided the animal noise attenuation earphone device of above, wherein at least one of: health data, performance data and GPS data is sent wirelessly to the external device.

According to an embodiment, there is provided the animal noise attenuation earphone device of above, wherein at least one of: health data, performance data and GPS data is stored in memory and downloaded through the USB port.

According to an embodiment, there is provided the animal noise attenuation earphone device of above, wherein the animal complementary data comprises at least one: of animal performance data and animal health data.

According to an embodiment, there is provided the animal noise attenuation earphone device of above, wherein the animal performance data comprises at least one of: a speed, a distance, a path, an acceleration, a jumping height, and a jumping pattern.

According to an embodiment, there is provided the animal noise attenuation earphone device of above, wherein the animal health data comprises at least one of: a blood pressure, a temperature, a brain activity and a heart rate.

According to an embodiment, there is provided the animal noise attenuation earphone device of above, further comprising a GPS module operatively connected to the processing device.

According to an embodiment, there is provided the animal noise attenuation earphone device of above, wherein the substantially resilient material comprises at least one of: an expansion foam, a memory foam, a silicon material, a gel, and a composite material.

According to an embodiment, there is provided the animal noise attenuation earphone device of above, wherein the core member has the form of the animal ear canal.

According to an embodiment, there is provided the animal noise attenuation earphone device of above, wherein the in-ear speaker, the outer-ear microphone and the in-ear canal microphone together define an active noise control system.

According to an embodiment, there is provided an animal noise attenuation earphone device comprising: a core member of a substantially resilient material adapted for filling an animal ear canal in a way to attenuate environmental sounds; an audio processing system within the core member for providing controlled sounds towards the animal ear canal, the audio processing system comprising: a processing device; an in-ear speaker operatively coupled to the processing device for providing the controlled sounds towards the animal ear canal at a frequency up to at least 35 kHz; an outer-ear microphone operatively coupled to the processing device for capturing environmental sounds; and an in-ear canal microphone operatively coupled to the processing device for receiving animal sounds; and a memory accessible by the processing device for storing at least one of: the controlled sounds and the animal sounds received.

According to an embodiment, there is provided the animal noise attenuation earphone device of above, further comprising a sensor operatively coupled to the processing device for collecting animal complementary data.

According to an embodiment, there is provided the animal noise attenuation earphone device of above, wherein the animal complementary data comprises at least one of animal performance data and animal health data.

### BRIEF DESCRIPTION OF THE DRAWINGS

Further features and advantages of the present disclosure will become apparent from the following detailed description, taken in combination with the appended drawings, in which:

FIG. 1 is a schematic perspective view of a passive noise attenuation earplug device adapted for horses according to the PRIOR ART;

FIG. 2 illustrates an interactive communication and tracking dog collar device in its application where a dog owner is in active communication with its dog throughout its collar, according to the PRIOR ART;

FIG. 3 is a schematic cross sectional view of two noise attenuation earphone devices (left and right) for animals according to an embodiment;

FIG. 4 shows a graphic that compares horse hearing sensitivity with human hearing sensitivity;

FIG. 5 is a block diagram of a noise attenuation earphone device according to another embodiment;

FIG. 6 shows an application of a noise attenuation earphone device according to another embodiment, where the device is wirelessly connected to external devices, namely a smartphone and a rider's headset;

FIG. 7 is a block diagram of a noise attenuation earphone device according to another embodiment;

FIG. 8 illustrates a mould of a horse's ear canal; and

FIG. 9 is a schematic cross sectional view of a noise attenuation earphone device (left or right) for animals according to another embodiment.

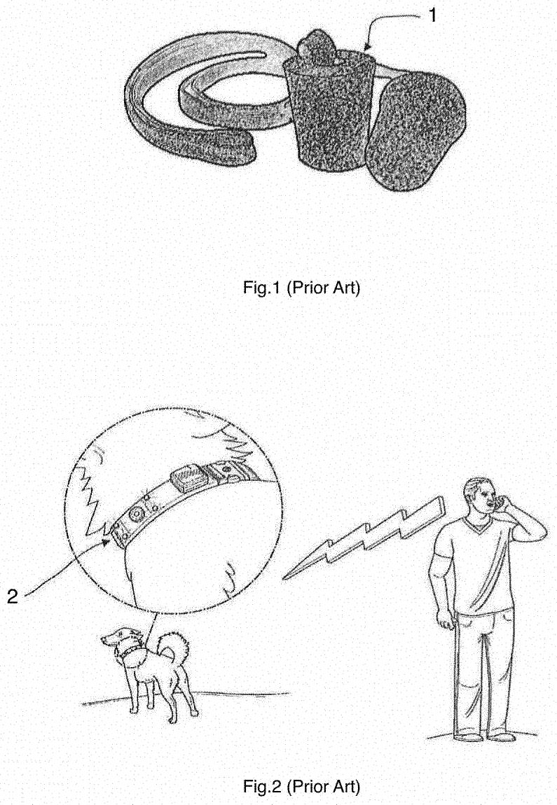

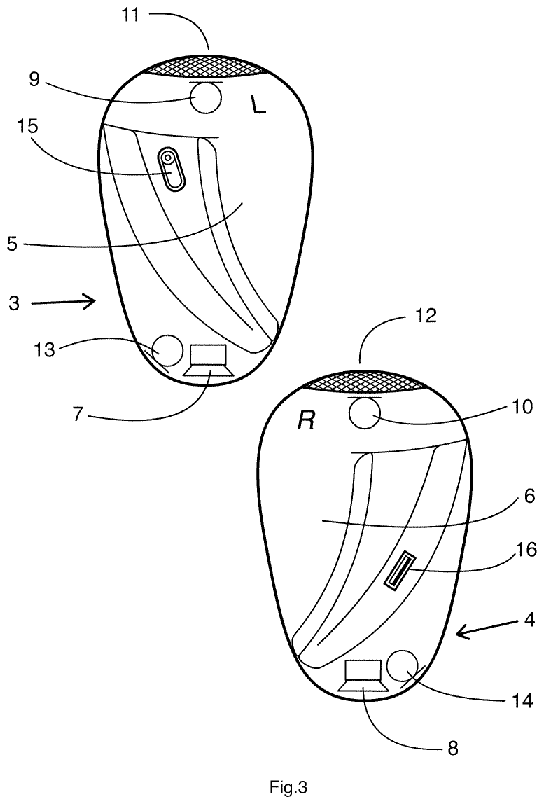

### DETAILED DESCRIPTION

An interactive animal earphone device for providing noise attenuation, as well as voice commands, in noisy environments is described. The device typically includes a core member, and an audio processing system (at least a processing device combined with an in-ear speaker, and alternatively, combined with an outer-ear microphone and an in-ear canal microphone) for capturing/transmitting/interpreting sounds from the animal (including biological noises captured in the ear canal) and digitally controlling over the animal perception of its sound environment. The earphone device may further include, without limitation, a tracking technology (GPS module), a gyroscope, health monitoring sensors, a wireless module, and a memory for storing data recorded from in-ear canal and outer-ear microphones and other sensors. Along with voice commands and sounds from the animal, data from all sensors, the gyroscope, and the GPS module can be sent to a receiving device or external device, such as, without limitation, a smartphone, a computer and/or a tablet, in real-time over a wireless network, either cellular network, WLAN or wireless personal area network (WPAN) (Bluetooth™).

Referring now to the drawings and more particularly to FIGS. 3, 5, 7 and 9, there is shown an animal noise attenuation earphone device 3, 4 (left and right devices 3, 4 shown in FIG. 3). Each one of the devices 3, 4 comprises a core member 5, 6 made with a substantially resilient material that is adapted to fill an animal ear canal (not shown) in a way to attenuate environmental sounds. The substantially resilient material may comprise, without limitation, an expansion foam, a memory foam, a silicon cushion, a gel, a composite material, and the like. Device 3 or 4 further comprises an audio processing system found to be within the core member 5, 6 for providing controlled sounds (i.e., music, a plurality of sounds, silence, and/or vocal commands from the animal's owner to the animal) towards the animal ear canal. The audio processing system comprises a processing device and an in-ear speaker 13, 14 operatively coupled to the processing device for providing the controlled sounds towards the animal ear canal. The audio processing system further comprises an outer-ear microphone 9, 10 operatively coupled to the processing device for capturing environmental sounds. It is to be noted that in another embodiment, in-ear speaker 13, 14 may be replaced by any other sound attenuation device, a filter element for instance, such as to filter sounds, or frequencies.

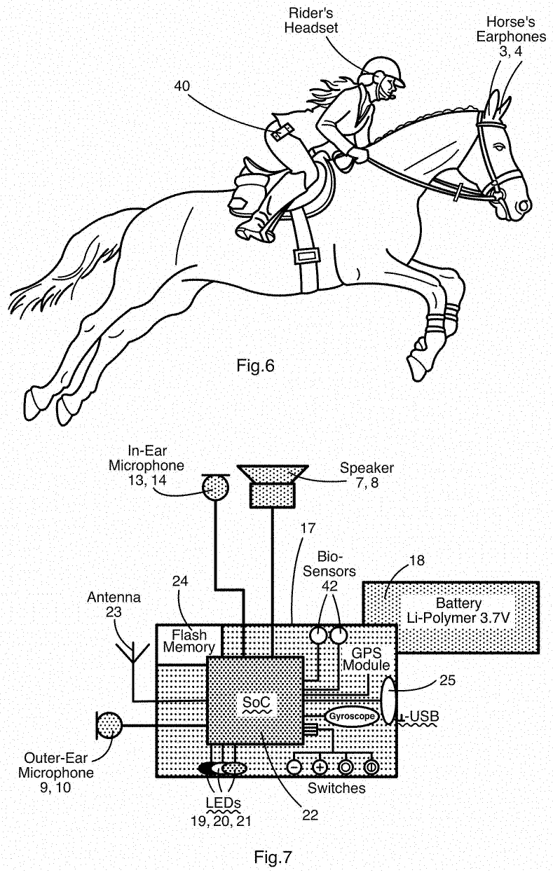

The audio processing system further includes an in-ear canal microphone 13, 14 operatively coupled to the processing device for receiving animal sounds and a memory 24 accessible by the processing device for storing the animal sounds received, or animal frequencies received (and/or any acoustic otoemission data from the animal received by the in-ear canal microphone), and/or the controlled sounds. Earphone device 3, 4 further comprise a communication module operatively connected to the processing device for receiving the controlled sounds and/or transmitting the animal sounds received. The communication module may be a USB port such as to receive a USB device storing data or alternatively, the communication module, or device, may be connected to the processing device for wirelessly/remotely receiving the controlled sounds and/or wirelessly/remotely transmitting the animal sounds received. According to such a scenario, the communication module may comprise a transmitting and receiving communication antenna 23 for wirelessly communicating with an external device 40, such as, without limitation, a phone device, a computer device, a headset device, an external microphone device, a music device and the like (see phone on FIG. 6).

According to an embodiment of the present disclosure, the animal noise attenuation device 3, 4, may therefore take the form of a wireless earphone system for remotely communicating with an animal, especially in a noisy or windy environment.

Indeed, the animal noise attenuation device 3, 4, allows both ambient noise attenuation (via in-ear speaker 7, 8 and outer-ear microphone 9, 10) and efficient communication with the animal (via in-ear speaker 7, 8). Device 3, 4 further provides enhanced attenuation at low frequencies, increased control of environmental sounds and two-ways communication, thanks to in-ear canal microphone 13, 14, providing sounds from the animal to its owner. It thus allows efficient hearing protection along with efficient two-ways communication via an improved human voice commands intelligibility, an environmental noise control, and a capture and interpretation of sounds from the animal.

Referring now to FIG. 3, left and right animal noise attenuation devices 3, 4 are presented. Each device 3, 4 typically includes an expansion foam or silicon cushion core 5, 6 providing ambient noise muffling, an in-ear speaker 7, 8, one (or more) outer-ear microphone 9, 10, alternatively with protection 11, 12, an in-ear canal microphone 13, 14, buttons 15 and USB connectors 16.

Each animal noise attenuation device 3, 4 typically comes with a processing device, such as an electronic controller in the form of a small PCB (printed circuit board) and a power source (a battery). FIG. 5 shows a simplified rendering of a PCB 17, a battery 18 and acoustic transducers 19, 20, 21. The PCB has an audio processing system on a chip (SoC) 22 with ADC, DAC, Digital Signal Processor, a wireless module, battery charging capabilities, a transmitting and receiving communication antenna 23, a flash memory or memory 24 for storing data, and a USB connector 25 for charging the battery or transferring data.

A person skilled in the art to which the present disclosure pertains will appreciate that animal noise attenuation device 3, 4 can use various wireless technologies and configurations such as, without limitation, Bluetooth™, WiFi and a cellular engine with independent RF (radiofrequency) chip, processor, and audio codec(s). It is also to be noted that left and right devices may be operatively connected such as to provide similar sound attenuation for both ears.

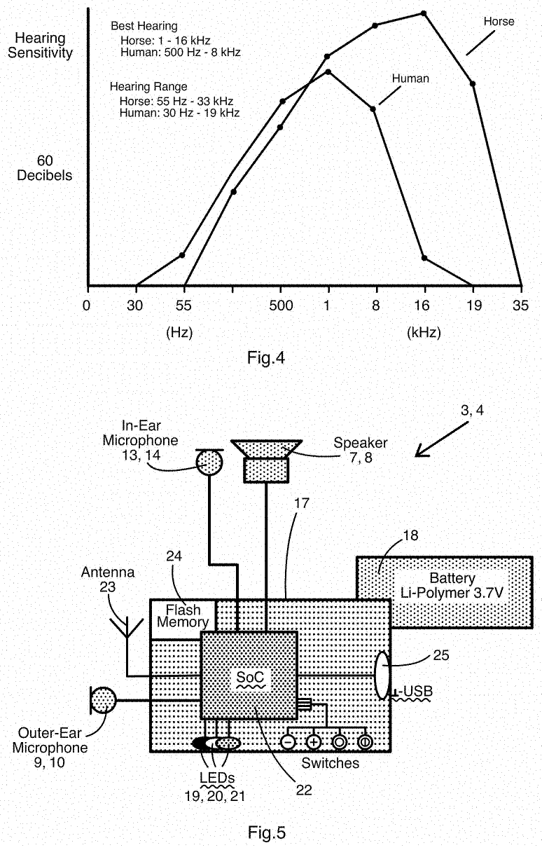

According to the animal noise attenuation earphone device described above, it is to be mentioned that in-ear speaker 7, 8 may operatively be coupled to the processing device for providing the controlled sounds towards the animal ear canal at a frequency up to at least 35 kHz. Indeed, it is further to be mentioned that animal hearing sensitivity (dogs, horses, and the like) is very different than human hearing sensitivity as better shown in FIG. 4, where a graphic compares horse hearing sensitivity with human hearing sensitivity. Although most of the human voice energy and therefore most of the voice commands are concentrated in the frequency band 150-6800 Hz, the way animal perceive human voice commands and identify the voice, is influenced by their maximum hearing perception, which is from 8 kHz to around 16 kHz (vs. 1 kHz to 5 kHz for human ear). Additionally, for controlling and for example recreating an attenuated real sound environment (the environmental sounds) with the outer-ear microphone 9, 10 and the in-ear speaker 7, 8, it may be necessary to respect the hearing frequency range of the animal. Device 3, 4 may then be designed with an extended frequency range, at least up to 35 kHz, based on the horse hearing range information provided in FIG. 4. Acoustic of earphone device 3, 4 may therefore be optimized after characterization of the acoustic impedance of the animal ear canal and eardrum system.

The animal noise attenuation earphone device 3, 4, as illustrated in FIGS. 3 and 5, may come with a number of applications. Indeed, while the substantially resilient material of core member 5, 6 provides ambient noise attenuation (passive noise reduction), the earphone device 3, 4 may be paired with a smartphone device or any other external device 40 or communication module. Therefore, earphone device 3, 4 may allow for remote, clear and intelligible voice commands even in acoustic challenging environments. It may further allow playing music wirelessly or via processing device coupled with memory 24 for relaxing the animal. Thanks to the in-ear canal microphone 13, 14, earphone device 3, 4 may additionally capture and transmit sounds from the animal (animal sounds) during a race, a ride, a police operation, and the like, without ambient noise corruption. In-ear canal microphone 13, 14 may also capture biological noises, such as, without limitation, heart rate, intestinal frequencies, and provide real-time info about the animal's health. On the other hand, the outer-ear microphone 9, 10 can be activated or deactivated depending on the ambient noise, as it is used for allowing a direct communication with the animal, while providing immersion of the animal in an attenuated sound environment by, for instance, allowing, for example, active noise control (ANC), or basic noise control.

It is to be mentioned that in a simple implementation of the earphone device 3, 4, earphone device may be designed with an in-ear speaker 7, 8 only, allowing voice commands or music playback.

According to an embodiment, the earphone device 3, 4 may further include a cellular engine so as to be connected to the cellular network.

According to an embodiment and referring now to FIG. 7, earphone device 3, 4 further comprises a sensor, which is operatively coupled to the processing device for collecting animal complementary data. The animal complementary data may include animal performance data (a speed, a distance, a path, an acceleration, a jumping height, a jumping pattern and the like) and/or animal health data (a blood pressure, a temperature, a heart rate, brain activity, brain waves and the like). As per example, earphone device 3, 4 may include a plurality of sensors, such as 9-axis gyroscope for tracking the animal performance concerning speed, ride distance, jumping height, jumping pattern, etc. Earphone device may additionally or alternatively include several biosensors for monitoring health parameters, such as blood pressure, temperature, heartbeat, etc. It is to be mentioned that such complementary data may be stored on memory 24 for further analysis. Sensing the animal is optimal as the canal itself is highly vascularised (i.e., blood pressure and heart rate may be measured with an oxymetry sensor). Thanks to the core member, internal temperature may be measured accurately inside the ear covered by the device, without ambient temperature influence.

According to an embodiment, earphone device 3, 4 further include a GPS module for tracking the animal in real time and/or storing all relevant geo-localization data onto memory 24.

Earphone device 3, 4 may further come with a set of applications designed for usual OS like Android or iOS running on smartphone, tablet or computers. These applications may include (1) firmware update for the earphone device 3, 4, (2) wireless earphone device customization, (3) wireless earphone device controls such as, without limitation, ON-OFF, volume, deep sleep and the like, (4) post processing of all data from the sensors and/or biosensors, the 9-axis gyroscope, and the GPS, stored in the earphone device memory or sent wirelessly in real-time.

It is to be noted that all data taken on earphone device's memory from any sensors and/or in-ear canal microphone may be used, according to a further application, to provide animal programs such as health and/or training programs, as a plurality of data may be analyzed from a plurality of animals (heart rate, brain activity, general health, speed, training time, and the like).

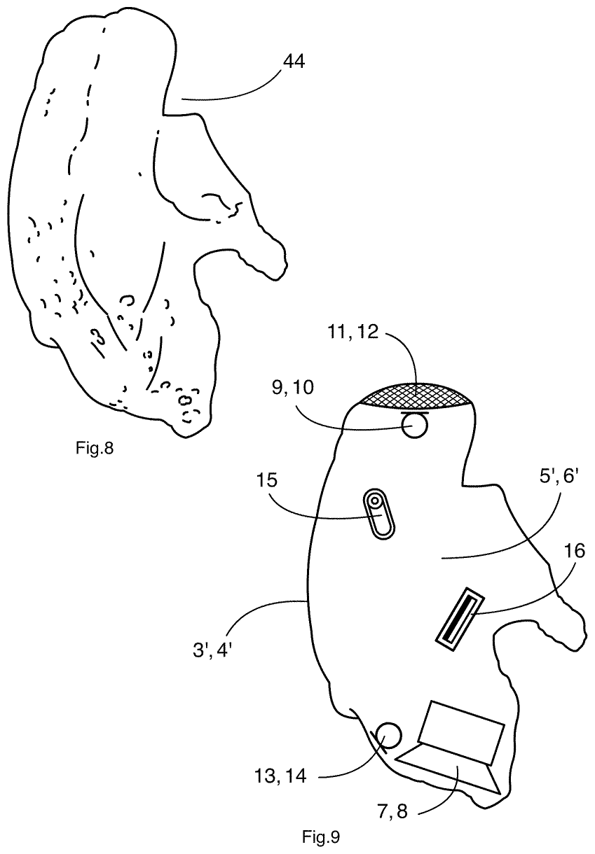

While the generic form of expansion foam or silicon cushion core 5, 6 of the earphone device 3, 4 provides ambient noise attenuation, in an alternative embodiment, such configuration may be improved by having the form of the expansion foam or silicon cushion 5, 6 to conform more closely to the ear canal of the animal. Indeed, referring now to FIG. 8, there is shown a mould 44 of an ear canal of a horse. Referring further to FIG. 9, from this mould 44, it is possible to create an earpiece device 3′, 4′, having expansion foam of silicon cushion core (or made of any other suitable resilient material) 5′, 6′ that generally conforms to the shape of the ear canal of the animal (of part of the cavity). The core 5′, 6′ may be made with, for example, E.A.R Earsoft™ material (which includes a polyurethane composition), and be in the form of a generic ear canal for the type of animal it is to be designed for or moulded expressly for a given animal. Indeed, according to the horse ear canal, shape of the core 5′, 6′ is important as it needs to fill the horse ear canal in a way to provide an efficient passive attenuation. It is to be understood that for conciseness, only one earpiece device has been shown and the form of the earpiece device 3′, 4′ will conform to the shape of the right of left ear canal depending on its intended use.

According to the above described earphone device, in-ear and outer ear microphones allows a two-ways communication with the animal, a digital control of the animal hearing over its full hearing frequency range, including total control on the animal perception of sound environment: various degrees of noise attenuation, noise cancellation, etc., and internal biological sounds capture and monitoring.

Furthermore, earphone device may be connected to a cellular network or to a smart-phone, tablet, laptop or any other communicating device through a short range wireless technology like Bluetooth™ or Wifi.

The two earpiece devices (left and right) can be connected with a cable or through a near-field wireless technology.

The many features and advantages of the invention are apparent from the detailed specification and, thus, it is intended by the appended claims to cover all such features and advantages of the invention that fall within the scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. An animal noise attenuation earphone device comprising:
a core member of a substantially resilient material adapted for filling an animal ear canal in a way to attenuate environmental sounds; and
an audio processing system within the core member for providing controlled sounds towards the animal ear canal, the audio processing system comprising:
a processing device; and
an in-ear speaker operatively coupled to the processing device for providing the controlled sounds towards the animal ear canal.

2. The animal noise attenuation earphone device of claim 1, wherein the audio processing system further comprises:
an outer-ear microphone operatively coupled to the processing device for capturing environmental sounds; and
an in-ear canal microphone operatively coupled to the processing device for receiving animal sounds.

3. The animal noise attenuation earphone device of claim 1, further comprising a memory accessible by the processing device for storing at least one of: the controlled sounds and the animal sounds received.

4. The animal noise attenuation earphone device of claim 1, further comprising a communication module operatively connected to the processing device for at least one of: receiving the controlled sounds and transmitting the animal sounds received.

5. The animal noise attenuation earphone device of claim 1, further comprising a USB port.

6. The animal noise attenuation earphone device of claim 4, wherein the communication module is connected to the processing device for at least one of: remotely receiving the controlled sounds and remotely transmitting the animal sounds received.

7. The animal noise attenuation earphone device of claim 6, wherein the communication module comprises:
a transmitting and receiving communication antenna for wireless communication with an external device.

8. The animal noise attenuation earphone device of claim 7, wherein the external device comprises at least one of: a phone device, a computer device, a headset device, an external microphone device and a music device.

9. The animal noise attenuation earphone device of claim 1, wherein the in-ear speaker is operatively coupled to the processing device for providing the controlled sounds towards the animal ear canal at a frequency up to at least 35 kHz.

10. The animal noise attenuation earphone device of claim 4, wherein the communication module is one of:
a cellular engine wirelessely connected to a cellular network;
a Wi-Fi module wirelessely connected to a Wi-Fi network; and
a Bluetooth module wirelessely connected to a Bluetooth network.

11. The animal noise attenuation earphone device of claim 1, further comprising a sensor operatively coupled to the processing device for collecting animal complementary data.

12. The animal noise attenuation earphone device of claim 11, wherein the animal complementary data comprises at least one: of animal performance data and animal health data.

13. The animal noise attenuation earphone device of claim 12, wherein the animal performance data comprises at least one of: a speed, a distance, a path, an acceleration, a jumping height, and a jumping pattern.

14. The animal noise attenuation earphone device of claim 12, wherein the animal health data comprises at least one of: a blood pressure, a temperature, a brain activity and a heart rate.

15. The animal noise attenuation earphone device of claim 1, further comprising a GPS module operatively connected to the processing device.

16. The animal noise attenuation earphone device of claim 15, wherein at least one of: health data, performance data and GPS data is sent wirelessly to the external device.

17. The animal noise attenuation earphone device of claim 16, wherein at least one of: health data, performance data and GPS data is stored in memory and downloaded through the USB port.

18. The animal noise attenuation earphone device of claim 1, wherein the substantially resilient material comprises at least one of: an expansion foam, a memory foam, a silicon material, a gel, and a composite material.

19. The animal noise attenuation earphone device of claim 1, wherein the core member has the form of the animal ear canal.

20. The animal noise attenuation earphone device of claim 2, wherein the in-ear speaker, the outer-ear microphone and the in-ear canal microphone together define an active noise control system.

21. An animal noise attenuation earphone device comprising:
a core member of a substantially resilient material adapted for filling an animal ear canal in a way to attenuate environmental sounds;
an audio processing system within the core member for providing controlled sounds towards the animal ear canal, the audio processing system comprising:
a processing device;
an in-ear speaker operatively coupled to the processing device for providing the controlled sounds towards the animal ear canal at a frequency up to at least 35 kHz;
an outer-ear microphone operatively coupled to the processing device for capturing environmental sounds; and
an in-ear canal microphone operatively coupled to the processing device for receiving animal sounds; and
a memory accessible by the processing device for storing at least one of: the controlled sounds and the animal sounds received.

22. The animal noise attenuation earphone device of claim 21, further comprising a sensor operatively coupled to the processing device for collecting animal complementary data.

23. The animal noise attenuation earphone device of claim 22, wherein the animal complementary data comprises at least one of animal performance data and animal health data.
